(19) United States
(12) Patent Application Publication
(10) Pub. No.: US 2008/0171575 A1
(43) Pub. Date: Jul. 17, 2008

(54) Application module for a personal communication device

(75) Inventors: Young Rak Choi, Palisades Park, NJ (US); Steven Kim, Palisades Park, NJ (US)

Correspondence Address: SEYFARTH SHAW, LLP, 815 CONNECTICUT AVENUE, N.W., SUITE 500, WASHINGTON, DC, 20006, US

(73) Assignee: HealthPia America, Palisades Park, NJ (US)

(21) Appl. No.: 11/653,354

(22) Filed: Jan. 16, 2007

(51) Int. Cl. H04B 1/40

(52) U.S. Cl. 455/557

(57) ABSTRACT

A communication device includes a processing part attached to a surface of the communication device for receiving first and second signals from the communication device and including a plurality of first contacts on a surface thereof, and a storage part mounted on the processing part and connected to the plurality of first contacts, wherein the processing part transmits a third signal to the communication device in response to the first signal and the processing part transfers the second signal from the communication device to the storage part in accordance with a portion of the second signal.

### BACKGROUND OF THE INVENTION

1. Field of the Invention

The present invention relates to a communication device, and more particularly, to an application module for a personal communication device. Although the present invention is suitable for a wide scope of applications, it is particularly suitable as an add-on device for a mobile phone.

2. Discussion of the Related Art

In general, personal communication devices are becoming more and more versatile. They provide many useful features in addition to basic point-to-point communication. For example, current personal communication devices, such as mobile phones, personal digital assistants, handheld, palmtop and pocket computers allow users to access the internet, send and receive text messaging, stream data into and out of the personal communication device, and view full motion video.

The availability of such an array of features enables the development of new services to increase the usefulness of those personal communication devices. For example, a service provider can provide value-added services or additional functions to a user by attaching an add-on application module to an existing personal communication device. The application module can receive data and commands from the communication device. Then, the application module can process the received data in accordance with the received command. Then, the application module can return a response to the communication device or perform a function depending on the received command.

The application module can be, or can include, a general purpose central processing unit (CPU) or a special purpose CPU, such as a digital signal processing (DSP) unit for performing intensive computations. Thus, the application module can provide additional processing power to the mobile phone. The application module can be provided with appropriate firmware for performing specific functions. For example, the user can use the application module to compress a short sequence of motion video to be stored on the application module or some other storage device, or to be communicated to another user over a mobile wireless communication system. The application module can be used to decode a video stream received by the mobile phone. The application module can also provide the capability of playing complex video games on the mobile phone.

FIG. 1 is a top view of an application module externally attached to a personal communication device in accordance with the related art. Referring to FIG. 1, the personal communication device is a flip-up mobile phone 100. The mobile phone 100 includes a body 110, a back cover (not shown), and a flipping cover 120. The body 110 incorporates a keypad (not shown) for alphanumeric entry. The user can, for example, use the alphanumeric keypad for entering text messages for sending to a service provider, for entering commands requesting specific functions to be performed by an attached device, or for entering data related to information to be stored on a storage device.

The flipping cover 120 incorporates a liquid crystal display (LCD) device 122. The LCD panel 122 can be used to display information for the user. For example, when the user is entering an alphanumeric data using the keypad, the LCD panel 122 can be used to display the message being entered by the user. Also, when messages are received from a service provider, the user can view the messages on the LCD panel 122. The LCD panel 122 can also be used to display status information related to an attached device, or a response provided from the attached device in accordance with a command entered by the user.

The mobile phone 100 includes a camera (not shown). The camera incorporated in the mobile phone 100 includes a lens 124. For example, the user can focus the lens 124 of the camera on a particular scene or subject. Then, the user can use the camera to capture a snapshot of the scene or subject or a short sequence of motion video of the scene or subject. Then, the user can store the captured image data from the snapshot or the short sequence of motion video to a storage device or sent to an application module for processing.

The mobile phone 100 is provided with a communication port 114, for example on the body of the mobile phone 100. The communication port 114 can be, for example, a serial communication port for communication with a serial communication device, such as an external application module, or some other external device. Commonly used serial communication ports can include the RS-232 communication protocol and the universal serial bus (USB) protocol. The mobile phone 100 can also communicate with an external device using a wireless connection. Bluetooth is an example of wireless connection for communication between a mobile phone and a nearby device. The communication port 114 can include a slot or receptacle for connecting an external device.

As shown in FIG. 1, an application module 130 can be externally attached to the mobile phone 100 and connected to the communication port 114. The application module 130 is provided with a connector 132. The connector 132, for example, an RS-232 connector, can be inserted into the communication port 114 of the mobile phone 100.

The related art external application device 130 dangles and hangs from the slot of the communication port 114 of the mobile phone 100. Thus, the related art external application device 130 is only attached via the serial communication port 114 and can easily fall of the mobile phone 100. Moreover, the user has to carry two separate devices, the mobile phone 100 and the external application module 130, and attach the application module 130 to the mobile phone 100 when needed. Thus, the related art external application device 130 can be cumbersome, discouraging the user from using it, therefore, reducing the use of the external application device 130.

FIG. 2A is an exploded side view of the related art personal communication device. As shown in FIG. 2A, the mobile phone 100 is provided with a battery 140 to increase mobility. The battery 140 is confined to a battery compartment 142 of the mobile phone 100 by a battery cover 150. Currently, in nearly all mobile phone device, the battery 140 is rechargeable. The battery 140 powers the mobile phone 100 and keeps the mobile phone 100 operational for an extended period of time. Rather than being hanged from an end of the mobile phone 100, an application module can be attached to the battery cover 146. A first connector (not shown) is provided in the battery compartment 142 for connecting the battery 140 to the mobile phone 100.

FIG. 2B is a side view of an application module attached to a surface of the personal communication device of FIG. 2A in accordance with the related art. Referring to FIG. 2B, an application module 160 is attached to a surface of the battery cover 150 of the mobile phone 100. The application module 160 can be screwed to the surface of the battery cover 150. The application module 160 can also be glued to the surface of the battery cover 150. The application module 160 is attached toward an end of the battery cover 150 leaving a remaining portion of the surface of the battery cover 150 uncluttered for easy handling by the user. Moreover, as shown in FIG. 2B, the lateral profile of the application module 160 is gradually sloped toward the surface of the battery cover 150 to extend the surface available for handling the mobile phone 100. A second connector (not shown) is provided through a battery cover slot (not shown) on the battery cover 150 for communication between the mobile phone 100 and an externally attached device.

FIG. 2C shows a bottom view of the application module attached to the surface of the personal communication device of FIG. 2B. Referring to FIG. 2C, the application module 160 is secured to the surface of the battery cover 150 through attachment holes 162. For example, the application module 160 can be screwed on the battery cover 150 through the attachment holes 162. A connector 164 is provided at an end of the application module 160 to engage a communication port of the mobile phone 100. The connector 164 can be inserted into the battery cover slot (not shown) provided on the battery cover 150.

The application module 160 is securely attached to the battery cover 150 rather than hanging from the body 110 of the mobile phone 100. Moreover, the application module 160 has a gradually sloped shape and is positioned toward an end of the battery cover 150 to facilitate the handling of the mobile phone 100 by a user. In spite of these advantages, the combination of the battery 140 (shown in FIG. 2A), the battery cover 150 (shown in FIGS. 2A and 2B), and the application module 160 can be bulky because of the need to provide the first and second connectors inside the battery compartment 142 and on the surface of the battery cover 150, respectively.

Another approach for connecting an application module to the mobile phone is to share an existing communication port on the mobile phone. By using an existing communication port, the need for additional connectors can be eliminated. The application module can be reduced in size. The resulting combination of the mobile phone and the application module can be made less bulky. An example of a communication port that can be shared by the application module is a smart card slot, such as a Subscriber Information Module (SIM) slot provided on the mobile phone.

FIG. 3 shows a perspective view of a personal communication device with a SIM receptacle in accordance with the related art. Referring to FIG. 3, the mobile phone 100 is provided with a smart card receptacle 320 for receiving a smart card. For example, the smart card receptacle 320 can be a SIM receptacle, such as a SIM slot, for inserting a SIM to be connected to the mobile phone 100. The SIM receptacle 320 includes a plurality of contacts 322 for contacting with corresponding contacts on the SIM, when the SIM is inserted into the SIM slot 320. Each of the contacts 322 is electrically connected to a corresponding electrical connector 324 routed from the mobile phone 100 through the SIM slot 320.

The SIM is a smart card that can be used for securely storing information about a subscriber to a mobile phone service. For example, the SIM can store subscriber identifying information, subscription information, preferences, and text messages. The SIM can also be used to store other information about the network, such as network state information, and the mobile phone current location information. Moreover, the SIM can store an electronic identity allowing the mobile phone user to access electronic services while the user is on the move. For example, the mobile phone 100 equipped with the SIM can allow access to public web kiosks, internet services, wireless multimedia streaming, electronic transactions and payments, mobile banking and e-commerce, etc.

The SIM can be used in GSM and across a wide rage of other wireless protocols and standards. For example, a removable user identity module (R-UIM) can be used as a dual-mode GSM provisioning and CDMA provisioning. CDMA subscribers can transfer the dual-mode R-UIM card from their CDMA mobile phone to a GSM mobile phone and have all their subscriber information available on the GSM network.

In order for an application module to share the SIM slot available on the mobile phone with the SIM, there is a need to develop an interface between the application module and the mobile terminal for exchanging and transferring information between the application module, the mobile phone and the SIM. The interface should provide for the concurrent operation of the SIM and the application module.

### SUMMARY OF THE INVENTION

Accordingly, the present invention is directed to an application module for a personal communication device that substantially obviates one or more of the problems due to limitations and disadvantages of the related art.

An object of the present invention is to provide an application module that provides an interface suitable for exchanging and transferring information between the application module, a personal communication device and a smart card.

Another object of the present invention is to provide application module securely and reliably attached to a personal communication device to enable ease of use.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an apparatus for connecting to a communication device includes a processing part including a plurality of first contacts on a surface thereof; a storage part removably mounted on the surface of the processing part and connected to the plurality of first contacts; and an adapter including on a surface thereof a plurality of second contacts corresponding to the first contacts, wherein the adapter transmits to the processing part a first signal received through the plurality of second contacts and the processing part processes the first signal in accordance with a portion of the first signal, and wherein the adapter transmits to the processing part a second signal received through the plurality of second contacts and the processing part transfers the second signal to the storage part through the plurality of first contacts based on a portion of the second signal.

In another aspect, a communication device includes a processing part attached to a surface of the communication device for receiving first and second signals from the communication device and including a plurality of first contacts on a surface thereof; and a storage part mounted on the processing part and connected to the plurality of first contacts, wherein the processing part transmits a third signal to the communication device in response to the first signal and the processing part transfers the second signal from the communication device to the storage part in accordance with a portion of the second signal.

In another aspect, an apparatus for connecting to a communication device includes a processing part; a first receptacle including a plurality of first contacts attached to a surface of the processing part; and an adapter including on a surface thereof a plurality of second contacts corresponding to the first contacts, wherein the adapter transmits to the processing part a first signal received through the plurality of second contacts and the processing part processes the first signal in accordance with a portion of the first signal, and wherein the adapter transmits to the processing part a second signal received through the plurality of second contacts and the processing part transfers the second signal to the plurality of first contacts based on a portion of the second signal.

It is to be understood that both the foregoing general description and the following detailed description are exemplary and explanatory and are intended to provide further explanation of the invention as claimed.

### DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a top view of an application module externally attached to a personal communication device in accordance with the related art;

FIG. 2A is an exploded side view of the related art personal communication device;

FIG. 2B is a side view of an application module attached to a surface of the personal communication device of FIG. 2A in accordance with the related art;

FIG. 2C shows a bottom view of the application module attached to the surface of the personal communication device of FIG. 2B;

FIG. 3 shows a perspective view of a personal communication device with a SIM receptacle in accordance with the related art;

FIG. 4 shows a planar view of an application module attachable to a personal communication device through an adapter in accordance with an embodiment of the present invention;

FIG. 5 shows a planar view of an application module attached to a personal communication device according to an embodiment of the present invention;

FIG. 6 shows a schematic cross-sectional view of the application module attached to the personal communication device of FIG. 5 through an adapter;

FIG. 7 illustrates a power-up operation of an application module interfacing a mobile phone and a SIM in accordance with an embodiment of the present invention;

FIG. 8 illustrates an operation of the application module in response to an input data from the mobile phone in accordance with an embodiment of the present invention; and

FIG. 9 illustrates an operation of the SIM in response to an input data from the mobile phone in accordance with an embodiment of the present invention.

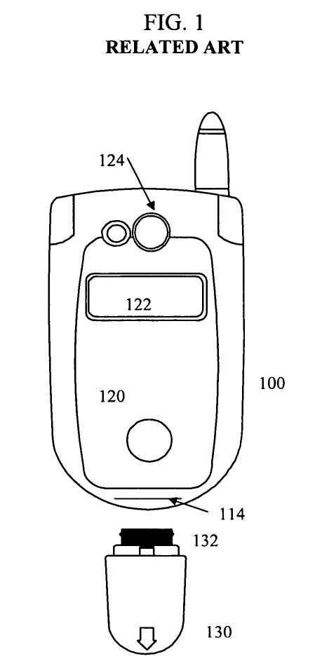

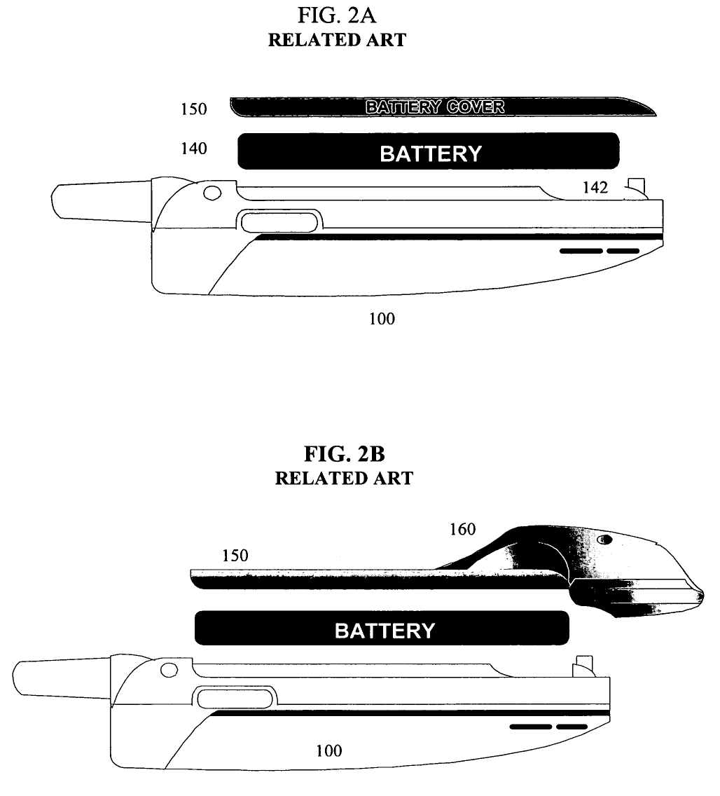

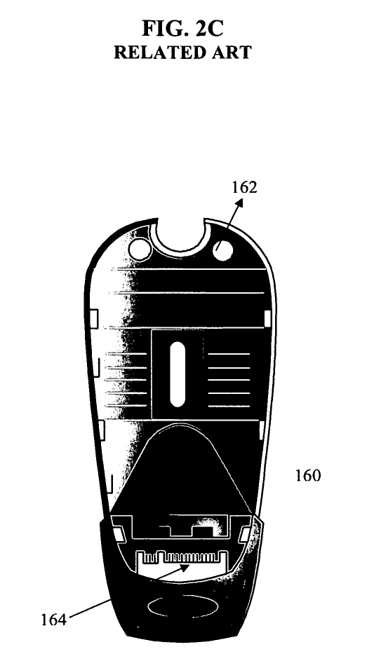

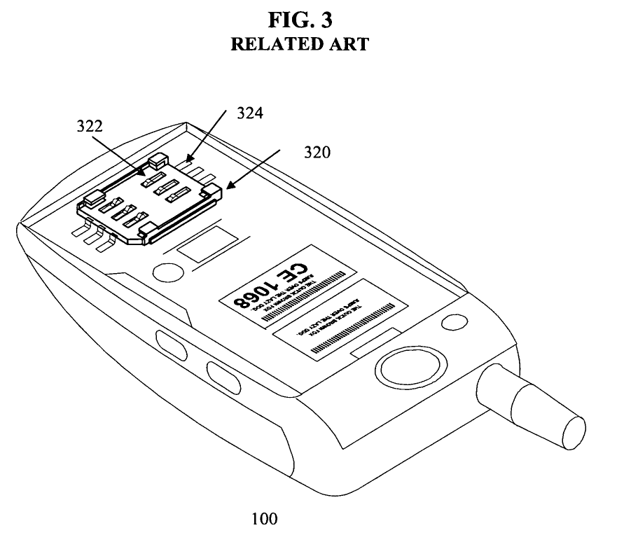

### DETAILED DESCRIPTION OF THE PREFERRED EMBODIMENTS

Reference will now be made in detail to the preferred embodiments of the present invention, examples of which are illustrated in the accompanying drawings.

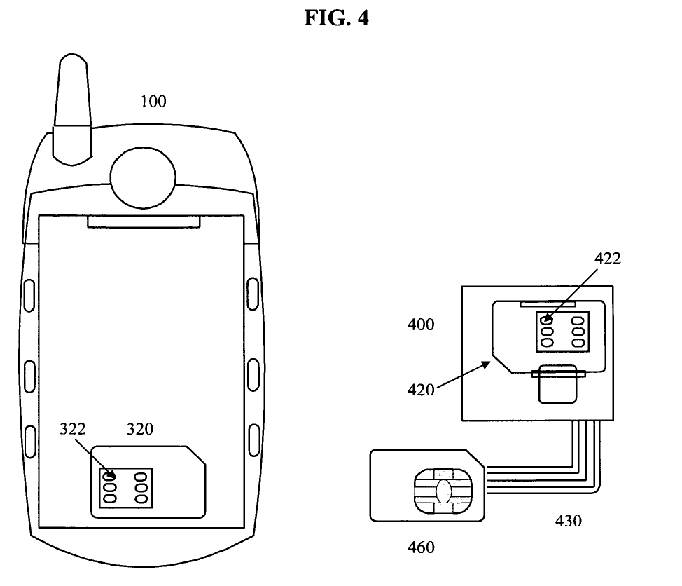

FIG. 4 shows a planar view of an application module attachable to a personal communication device through an adapter in accordance with an embodiment of the present invention. Referring to FIG. 4, a mobile phone 100 is provided with a smart card receptacle 320 or a slot for receiving a smart card, such as a SIM. The SIM can normally be inserted in the SIM receptacle 320 for exchanging information between the SIM and the mobile phone 100. As described above, the SIM receptacle 320 includes a plurality of contacts 322 for contacting with corresponding contacts on the SIM, when the SIM is inserted into the SIM slot 320. Each of the contacts 322 is electrically connected to a corresponding electrical connector (not shown) routed from the mobile phone 100 through the SIM slot 320.

The mobile phone 100 is provided with an application module 400 for increasing usability by allowing additional functions to be performed through the application module 400. The application module 400 is provided with a SIM receptacle 420 for receiving a smart card, such as a SIM, which can be used as a storage device. The SIM is removably mounted on the application module 420 by insertion into the SIM receptacle 420. The SIM receptacle 420 on the application module 420 includes a plurality of contacts 422 for contacting with corresponding contacts on the SIM, when the SIM is inserted into the SIM slot 420. Each of the contacts 422 on the application module 400 is electrically connected to a corresponding electrical connector (not shown) routed from the application module 400 through the SIM receptacle 420 for exchanging information between the SIM and the application module 400.

An adapter 460 is provided for connecting the application module 400 to the SIM receptacle 320 on the mobile phone 100. The adapter 460, for example a SIM adapter, can be made of the same shape and size as a SIM. The adapter 460 includes on a surface thereof a plurality of contacts (not shown) in a matching correspondence with the contacts on a SIM. The adapter 460 is inserted into the SIM receptacle 320 on the mobile phone 100 in a manner similar as a SIM to receive a communication signal from the mobile phone 100 through the plurality of contacts 322. The adapter 460 transmits the communication signal received from the mobile phone 100 to the application module 400.

An extension cable 430 is provided for connecting the adapter 460 to the application module 400. The extension cable includes a plurality of connectors for connecting the contacts (not shown) from the adapter 460 to corresponding contacts (not shown) on the application module 400. The communication signals received from the mobile phone 100 through the contacts 322 on the mobile phone 100 are carried on the extension cable 430 to be transmitted to the application module 400.

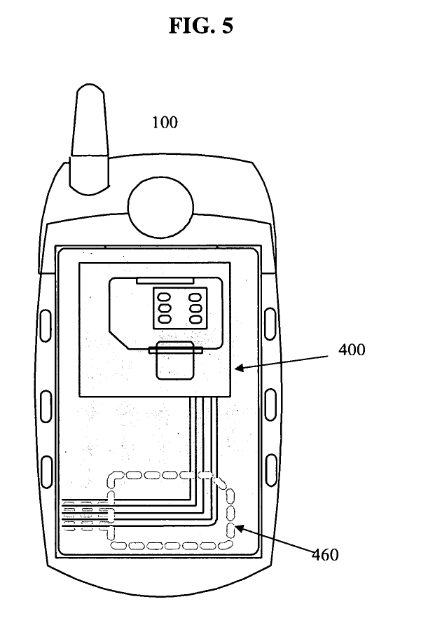

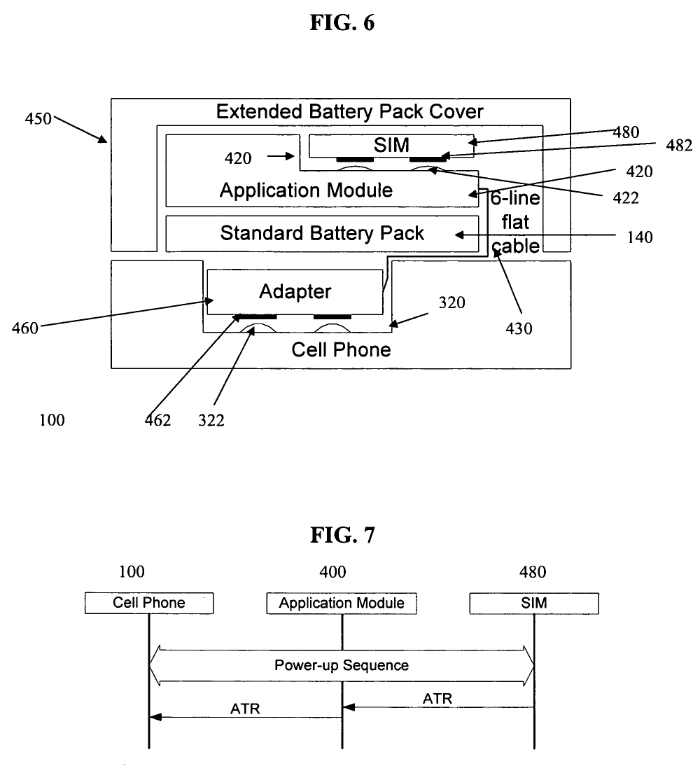

FIG. 5 shows a planar view of an application module attached to a personal communication device according to an embodiment of the present invention. FIG. 6 shows a schematic cross-sectional view of the application module attached to the personal communication device of FIG. 5 through an adapter. Referring to FIGS. 5 and 6, the adapter 460 is connected to the mobile phone 100, for example, by insertion into the SIM receptacle 320. As shown in FIG. 5, contacts 462 from the adapter 460 connect to corresponding contacts 322 on the SIM receptacle 320. The remaining contacts (not shown) on the adapter 460 also connect to corresponding contacts on the SIM receptacle 320.

The battery 140 is connected to the mobile phone 100 over the SIM receptacle 320 including the adapter 460. The application module 400 is attached to a top surface of the battery 140. A SIM 480 is attached to the SIM receptacle 420 on the surface of the application module 400. As shown in FIG. 5, contacts 482 and 485 from the SIM 480 connect to corresponding contacts 422 and 425 on the SIM receptacle 420. The remaining contacts (not shown) on the SIM 480 also connect to corresponding contacts on the SIM receptacle 420.

As shown in FIG. 6, the adapter 460, the battery 140, the application module 400 and the SIM 480 are stacked on top of each other. The extension cable 430 extends from the application module 400 on the back of the battery 140 to reach the adapter 460 under the battery 140 by folding around a side of the battery 140. The extension cable 430 can be, for example, a 6-line flat cable. A battery cover 450 covers the stack of the adapter 460, the battery 140, the application module 400 and the SIM 480.

The mobile phone 100 provides a supply voltage VCC (not shown) on one of the contacts 322. A ground voltage GROUND (not shown) is provided on a second one of the contacts 322. The mobile phone 100 can send a reset signal to the SIM 480 or the application module 400 by providing a reset voltage RESET on a third of the contacts 322. Programming of the application module 400 or the SIM 480 can be performed by providing a programming voltage VPP on a fourth of the contacts 322. The mobile phone 100 provides a clock signal CLOCK on a fifth contact 322. The mobile phone 100 sends input data signals to and receives output data signals from the application module 400 or the SIM 480 through a sixth contact 322, which is used as an I/O contact.

The adapter 460 transmits all electrical signals, including the input data signals, transmitted from the mobile phone 100 through the contacts 322 to the application module. For example, the VCC, VPP, GROUND, RESET, CLOCK and I/O signals provided on the contacts 322 by the mobile phone 100 are transmitted to the application module 400 via the extension cable 430. In turn, the application module 400 transmits some of the electrical signals, excluding the input data signals, received from the adapter 460 to the SIM 480. For example, the application module 480 transmits the VCC, VPP, GROUND, RESET, and CLOCK signals to the attached SIM 480 through the contacts 422, respectively, for keeping the SIM 480 operational concurrently with the application module 400.

As described above, the mobile phone 100 sends input data signals to and receives output data signals from the application module 400 or the SIM 480 through the I/O contact. If the application module 400 is the destination of an input data signal sent by the mobile phone 100 and transmitted to the application module 400 by the adapter 460 via the I/O contact, the application module 400 processes the input data signal in accordance with a function to be performed. If the SIM 480 is the destination of an input data signal sent by the mobile phone 100 and transmitted to the application module 400 by the adapter 460 via the I/O contact, the application module transmits the input data signal to the SIM 480 via the I/O contact. Similarly, when an output data signal is transmitted by the SIM 480 and received by the application module 400 through the I/O contact, the application module 400 transmits the output data signal to the adapter 460, which in turn provides the output data signal to the mobile phone 100 on the I/O contact.

FIG. 7 illustrates a power-up operation of an application module interfacing a mobile phone and a SIM in accordance with an embodiment of the present invention. Referring to FIG. 7, during a power-up sequence, the SIM 480 transmits an answer to reset (ATR) information to the application module 400. The application module 400 transfers the ATR information to the mobile (cell) phone 100 via the extension cable 430 (shown in FIG. 6). The ATR information can include, for example, operational requirements of the SIM 480. The ATR includes a sequence of characters. For example, the initial character sent in the ATR can specify a coding convention for all subsequent characters. The second character sent in the ATR can be a format character. Additional characters can be sent to characterize the interface by specifying, for example, the programming voltage and the protocol type required by the SIM 480.

FIG. 8 illustrates an operation of the application module in response to an input data from the mobile phone in accordance with an embodiment of the present invention. Referring to FIG. 8, the mobile phone 100 sends a request information including input data signals to the application module 400. The request information also includes a header information identifying, for example, the destination of the request as either the application module 400 or the SIM 480. The input data signals transmitted from the mobile phone 100 through the adapter 400 to the application module 400 can be, for example, a new firmware for upgrading the operation of the application module 400. The input data signals can also be input data to be operated on by the application module 400.

The application module 400 processes the request including the input data signals received from the mobile phone 100. For example, the application modules decodes the header information to find the final destination of the request, including the input data signals. In this instance, the application module 400 is the destination for the sent request. Then, the application module 400 processes the request by performing the functions in accordance with the particular request as specified by the header. Then, the application module 400 sends a response to the mobile phone 100 through the adapter 460.

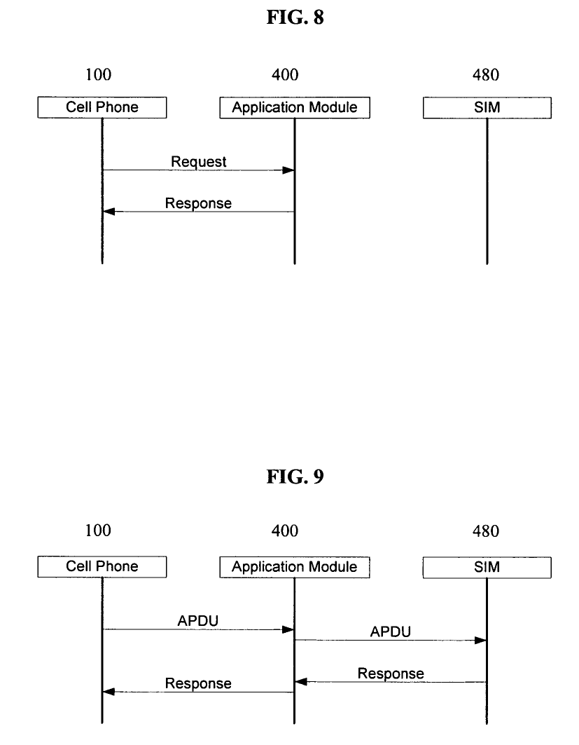

FIG. 9 illustrates an operation of the SIM in response to an input data from the mobile phone in accordance with an embodiment of the present invention. Referring to FIG. 9, the mobile phone 100 sends an application protocol data unit (APDU) including input data signals to the application module 400. The APDU also includes a header information identifying, for example, the destination of the request as either the application module 400 or the SIM 480. In this instance, the SIM 480 is the destination of the APDU. The input data signals can be information to be stored in the SIM 480, or request for downloading information from the SIM 480 to the mobile phone 100.

After identifying the SIM 480 as the destination of the APDU, the application module 400 transmits the received APDU to the SIM 480 through the contacts 422 (shown in FIG. 6). Then, the SIM 480 processes the received APDU by performing the requested functions in accordance with the particular request as specified by the header. Then, the SIM 480 sends a response to the application module 400, which transmits the response from the SIM 480 to the mobile phone 100 through the adapter 460.

In accordance with an embodiment of the present invention, the adapter, the battery, the application module and the SIM are stacked on top of each other in the battery compartment of the mobile phone. The application module and the interface circuitry are fitted in the battery compartment and covered with the battery cover. Thus, none of the application module and the interface circuitry are exposed to the outside of the phone. Accordingly, the mobile phone remains slim and does not have any attachment hanging or dangling from any surface thereof. Thus, the mobile phone remains easy to handle, even with the presence of the application module.

In accordance with an embodiment of the present invention, the application module shares a communication port with the SIM by transmitting to the SIM information that are identified as having the SIM as the destination. Accordingly, no hardware change has to be made to the mobile phone 100 to accommodate the new functions provided by the application module.

It will be apparent to those skilled in the art that various modifications and variations can be made in the application module for a personal communication device of the present invention without departing from the spirit or scope of the invention. Thus, it is intended that the present invention cover the modifications and variations of this invention provided they come within the scope of the appended claims and their equivalents.

What is claimed is:

1. An apparatus for connecting to a communication device, comprising:
a processing part including a plurality of first contacts on a surface thereof;
a storage part removably mounted on the surface of the processing part and connected to the plurality of first contacts; and
an adapter including on a surface thereof a plurality of second contacts corresponding to the first contacts,
wherein the adapter transmits to the processing part a first signal received through the plurality of second contacts and the processing part processes the first signal in accordance with a portion of the first signal, and
wherein the adapter transmits to the processing part a second signal received through the plurality of second contacts and the processing part transfers the second signal to the storage part through the plurality of first contacts based on a portion of the second signal.

2. The apparatus of claim 1, wherein the communication device sends the first and second signals to the adapter.

3. The apparatus of claim 2, wherein the storage part transmits a third signal to the processing part in response to the second signal and the processing part transmits the third signal to the communication device.

4. The apparatus of claim 2, wherein the communication device includes a battery part attached to the processing part and placed between the adapter and the processing part.

5. The apparatus of claim 4, further comprising a connector for connecting the processing part to the adapter.

6. The apparatus of claim 5, wherein the connector extends from a first surface of the battery part to a second surface of the battery part by folding around a side of the battery part.

7. The apparatus of claim 2, wherein the communication device includes a receptacle for connecting the adapter to the communication device.

8. The apparatus of claim 2, wherein the storage part includes a SIM card.

9. The apparatus of claim 2, wherein the adapter includes a SIM adapter.

10. The apparatus of claim 1, further comprising a receptacle on the processing part for mounting the storage part on the processing part.

11. A communication device, comprising:
a processing part attached to a surface of the communication device for receiving first and second signals from the communication device and including a plurality of first contacts on a surface thereof; and
a storage part mounted on the processing part and connected to the plurality of first contacts,
wherein the processing part transmits a third signal to the communication device in response to the first signal and the processing part transfers the second signal from the communication device to the storage part in accordance with a portion of the second signal.

12. The apparatus of claim 11, wherein the storage part transmits a fourth signal to the processing part in response to the second signal and the processing part transmits the fourth signal to the communication device.

13. The apparatus of claim 11, further comprising an adapter for connecting the processing part to the communication device and transferring the first and second signals to the processing part.

14. The apparatus of claim 13, further comprising a battery part attached to the processing part and placed between the adapter and the processing part.

15. The apparatus of claim 14, further comprising a connector for connecting the processing part to the adapter.

16. The apparatus of claim 15, wherein the connector extends from a first surface of the battery part to a second surface of the battery part by folding around a side of the battery part.

17. The apparatus of claim 12, wherein the adapter includes a SIM adapter.

18. The apparatus of claim 11, wherein the storage part includes a SIM card.

19. The apparatus of claim 11, further comprising a receptacle on the processing part for mounting the storage part on the processing part.

20. An apparatus for connecting to a communication device, comprising:
a processing part;
a first receptacle including a plurality of first contacts attached to a surface of the processing part; and
an adapter including on a surface thereof a plurality of second contacts corresponding to the first contacts,
wherein the adapter transmits to the processing part a first signal received through the plurality of second contacts and the processing part processes the first signal in accordance with a portion of the first signal, and
wherein the adapter transmits to the processing part a second signal received through the plurality of second contacts and the processing part transfers the second signal to the plurality of first contacts based on a portion of the second signal.

21. The apparatus of claim 20, further comprising a storage part inserted in the receptacle attached to the surface of the processing part to be connected to the plurality of first contacts.

22. The apparatus of claim 21, wherein the adapter and the storage part have substantially the same shape and size.

23. The apparatus of claim 21, wherein the storage part transmits a third signal to the processing part in response to the second signal and the processing part transmits the third signal to the adapter.

24. The apparatus of claim 21, further comprising a battery part attached to the processing part and placed between the adapter and the processing part.

25. The apparatus of claim 24, further comprising a connector for connecting the processing part to the adapter.

26. The apparatus of claim 25, wherein the connector extends from a first surface of the battery part to a second surface of the battery part by folding around a side of the battery part.

27. The apparatus of claim 21, wherein the storage part includes a SIM card.

28. The apparatus of claim 20, further comprising a communication device for sending the first and second signals to the adapter.

29. The apparatus of claim 28, further comprising on a surface of the communication device a second receptacle for inserting the adapter.

30. The apparatus of claim 29, wherein the first and second receptacles have substantially the same shape and size.

31. The apparatus of claim 20, wherein the adapter includes a SIM adapter.
